(19) United States
(12) Patent Application Publication
(10) Pub. No.: US 2014/0015345 A1
(43) Pub. Date: Jan. 16, 2014

(54) CURRENT LIMITING CIRCUIT FOR ELECTRICAL DEVICES

(71) Applicant: iLumisys, Inc, Troy, MI (US)

(72) Inventors: John Ivey, Farmington Hills, MI (US); David L. Simon, Grosse Pointe Woods, MI (US); Frank Palazzolo, Rochester, MI (US); Hoan Ngo, Sterling Heights, MI (US)

(73) Assignee: iLumisys, Inc, Troy, MI (US)

(21) Appl. No.: 13/938,534

(22) Filed: Jul. 10, 2013

Related U.S. Application Data
(60) Provisional application No. 61/669,850, filed on Jul. 10, 2012.

(51) Int. Cl. H02H 9/02

(52) U.S. Cl. CPC H02H 9/02
USPC 307/326

(57) ABSTRACT

A current limiting circuit for use with an electrical device may include a test load and a test load switch operable for varying an electrical current flowing through the test load. A detector may be electrically connected to the test load for detecting variations in an electrical characteristic of the test load and generating a detector output signal indicative of the electrical characteristic. A detection threshold signal source may be provided for producing a detection threshold signal. A comparator may be electrically connected to the detector and the threshold signal source, the comparator operable for generating a load switch control signal based at least in part on the detector output signal and the detection threshold signal. A load switch may be electrically connected to the comparator and operable for adjusting a current flow through a main load in response to the load switch control signal.

### CROSS-REFERENCE TO RELATED APPLICATIONS

This application claims the benefit of U.S. Provisional Application Ser. No. 61/669,850, filed Jul. 10, 2012, entitled “CURRENT LIMITING CIRCUIT FOR ELECTRICAL DEVICES”, the content of which is hereby incorporated by reference in its entirety.

### FIELD OF THE INVENTION

The present invention pertains to a system and method for protecting a person from electrical shock when interacting with an electrical device.

### BACKGROUND

Incandescent light bulbs may be used in various environments, such as households, commercial buildings, and advertisement lighting, and are used in many types of fixtures, such as desk lamps and overhead fixtures. Incandescent bulbs may have a threaded electrical connector for use in Edison-type fixtures, though incandescent bulbs can include other types of electrical connectors such as a bayonet connectors or pin connectors. Incandescent light bulbs may consume large amounts of energy and have short life-spans.

Compact fluorescent light bulbs (CFLs) and light emitting diode based (LED-based) lights are gaining popularity as replacements for incandescent light bulbs. CFLs and LED-based lights may be much more energy efficient than incandescent light bulbs and may have significantly longer life spans than incandescent light bulbs. However, there may be drawbacks to using CFLs, LED-based lights, and other line-powered electrical devices.

Some line-powered electrical devices use a permanent wired connection or a unitary plug and socket connection that simultaneously connect a power, return, and safety ground at the same general location. A few devices provide separate connectors for power and return. In some of these devices, if the power terminal is connected using one connector and the subject, for example a person installing a new bulb, comes into contact with the return terminal in another connector that has not yet been mated, the person may receive a shock by completing the circuit from the return terminal to ground.

### BRIEF DESCRIPTION OF THE DRAWINGS

The description herein makes reference to the accompanying drawings, wherein like reference numerals refer to like parts throughout the several views, and wherein:

FIG. 1 is an electrical schematic diagram of an exemplary current limiting circuit;

FIG. 2 is an electrical schematic diagram of an exemplary current limiting circuit including a detection validation circuit;

FIG. 3 is an electrical schematic diagram of an exemplary current limiting circuit including a main load shut-off circuit; and

### DETAILED DESCRIPTION

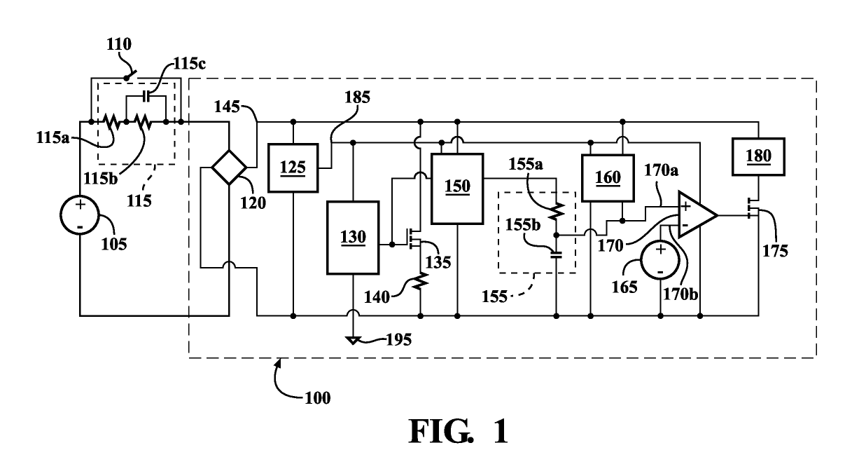

FIG. 1 illustrates an electrical schematic diagram of an exemplary current limiting circuit 100. The current limiting circuit 100 operates to electrically detect the presence of a foreign object, for example, a person's body, in the circuit path and limit the flow of current through the object while allowing substantially full current to flow when an intended electrical connection is established between a power source and load. The current limiting circuit 100 may be used as a peripheral circuit to reduce or eliminate the active current traveling through a power rail of a main circuit including current conducted to any load attached to the main circuit. Generally, the current limiting circuit 100 permits the main circuit to be turned off when there are variations in the electrical characteristics of the power supplied to the current limiting circuit 100 due to a subject, for example a human body, coming into physical contact with the main circuit. Detection of the subject may be accomplished by drawing a relatively small, varying test current from a low-impedance power source 105 through a test load switch 135 and a Z test load 140, and measuring a voltage variation at a device supply rail 145. If a direct, low-impedance connection from the power source 105 to the current limiting circuit 100 is present, the voltage variation at the device supply rail 145 will be minimal due to the low impedance of the power source 105 and the conductors connecting it to the current limiting circuit 100. In this case, a main load 180 will be powered on. If a subject, for example a human body (electrically represented by a human body resistor-capacitor model 115), is interposed between the power source 105 and the current limiting circuit 100, the extra impedance of the subject will cause the varying test current to produce a varying voltage at the device supply rail 145. If this varying voltage exceeds a selected limit, a subject is presumed to be in electrical contact with the power circuit, and a main load switch 175 remains off, thereby maintaining the current flowing through the subject at a low and safe level.

The current limiting circuit 100 may be incorporated into the main circuit or can be a separate circuit providing control signals to the main circuit. If the current limiting circuit 100 of FIG. 1 is incorporated into the main circuit, the current limiting circuit 100 may be electrically connected directly to a main load 180 or may be electrically connected directly to a power supply that connects directly to the main load 180. If the current limiting circuit 100 is provided as a separate circuit, the current limiting circuit 100 may provide the necessary control signals to the main load 180 or the power supply, such that the current limiting circuit 100 can limit the current traveling through the main load 180. An electrical connection between two or more circuit elements can be made by wire, printed circuit board traces, and/or any other method of making electrical connections between such circuit elements, or a combination thereof.

The current limiting circuit 100 can be connected to the power input 105, which may provide power for the main load 180 and the current limiting circuit 100. The power input 105 can be an AC power input or any other suitable power source (e.g. DC power input). The power input 105 may provide power for the main load 180, and the current limiting circuit 100 can be powered from a power source separate from the power input 105. The power input 105 may alternatively provide power for the current limiting circuit 100, and the main load 180 can be powered from a power source separate from the power input 105.

With continued reference to FIG. 1, the current limiting circuit 100 operates to distinguish between a normal circuit configuration, in which the current limiting circuit 100 is connected directly to the power source 105, and a fault configuration, in which the current limiting circuit 100 is connected to the power source 105 through a subject, for example, a person's body. In the normal circuit configuration, the current limiting circuit 100 may be connected to the power source 105 via wiring, connectors, and other circuit elements, represented in FIG. 1 by switch 110 in a closed position. In the fault configuration, the current limiting circuit 100 may be connected to the power source 105 via a subject, represented in FIG. 1 by switch 110 in an open position, and the human body resistor-capacitor model 115.

By way of example, the subject represented can be a human body, a human body model, or any other foreign body, object, or other non-circuit element that may come into contact across the input end and the output end of the main switch 110, or be present in the circuit so as to be located in series with the main switch 110. For example, the representation of the subject can be a human body model 115 consisting of a network of resisters and capacitors. Specifically, the human body model 115 can be represented by a first model resistor 115a, a second model resistor 115b and a model capacitor 115c. The first model resistor 115a may be electrically connected with the second model resistor 115b in series. The second model resistor 115b may be further electrically connected with the model capacitor 115c in parallel. As an example, a human body can be represented using the human body model 115 with the model resistor 115a at 500 ohms, the model resistor 115b at 1500 ohms, and the model capacitor 115c at 0.2 micro Farads, though alternate values may be used for the model as needed.

Electrical power from power input 105 may be delivered to a rectifier 120. A transformer or other power conversion element may be interposed between the power input 105 and the rectifier 120. The rectifier 120 may be a full wave rectifier or a half-wave rectifier. By way of example, the full wave rectifier may be constructed using four diodes arranged in a bridge configuration if the power input 105 is single-phase AC. The full wave rectifier may also be constructed using only two diodes, or even one. The full wave rectifier may have a center-tap connection to a transformer. The full wave rectifier may further be constructed using six diodes if the power input 105 is a three-phase AC. The rectifier 120 may include a smoothing capacitor or other element which further processes the electrical current received power input 105. The rectifier 120 need not necessarily be part of the current limiting circuit 100. For example, the power input might be rectified elsewhere or provided from a DC source. The main load 180 may be configured to use AC power or the current limiting circuit 100 could be powered in other ways. The rectifier 120 may also be replaced with any combination of discrete or integrated components, such that the wave form of the power input 105 can be converted from a full wave form to a rectified wave form, for example, from an AC wave to a DC wave.

An output of the rectifier 120 may be electrically connected to an input of an auxiliary power supply 125 and a device power rail 145. The auxiliary power supply 125 may be configured to provide a current and a voltage where the total power and total current provided by the auxiliary power supply 125 is less than the total power and total current provided by the power input 105. The auxiliary power supply 125 can also provide an alternating current.

The auxiliary power supply 125 may be configured to provide a minimum power and current to operate an impedance detection circuit. The minimum power and current needed to operate the impedance detection circuit may depend on the specific circuit elements used in the particular implementation of the impedance detection circuit. For example, the auxiliary power supply 125 may output a voltage of 5V and an output current sufficient to power the impedance detection circuit. In one exemplary configuration, the auxiliary power supply 125 may be constructed from a network of circuit elements that may be discrete, integrated, or a combination thereof. The auxiliary power supply 125 may be constructed from a selection of circuit elements to output the desired total power and total current for the impedance detection circuit.

The auxiliary power supply 125 may be part of an AC power transformer. For example, the auxiliary power supply 125 may in part comprise a secondary winding of the AC power transformer or a separate step-down power transformer. In such configurations, the auxiliary power supply 125 may include the rectifier 120, in which case the auxiliary power supply 125 may have a direct electrical connection to the power input 105. In another exemplary configuration, the auxiliary power supply 125 may be powered by a separate power source from the power input 105. For example, the auxiliary power supply 125 may be powered by or partly comprise rechargeable or non-rechargeable batteries and/or photovoltaics. The auxiliary power supply 125 may also be configured such that it is powered by any external source, for example, a stand-alone battery.

An output of the auxiliary power supply 125 may be electrically connected to an auxiliary power rail 185 that is further electrically connected to a power input of an oscillator 130. The oscillator 130 may be electrically connected to a ground 195 or to any other power source or ground. The oscillator 130 may be configured as a harmonic-type oscillator or a relaxation-type oscillator, a crystal oscillator, a ring oscillator, a silicon micromechanical resonator, an oscillating output of a digital circuit or microprocessor, or any other type of oscillator. The output of the oscillator 130 may be a digital, continuous time output, a varying sinusoidal output, or another type of output. The oscillation frequency may be greater than the frequency of the power input 105. The oscillation frequency may also be an integral multiple of the frequency of the power input 105.

By way of an example, an oscillation frequency of 300 Hz would provide an integral number of oscillation cycles per AC line cycle for both 50 Hz and 60 Hz lines frequencies. Selecting a frequency that is a multiple or submultiple of the AC line frequency may also assist inreducing noise pickup from stray AC voltages by a detector 150 by averaging the detection signal over an integral number of AC cycles, causing the positive and negative cycles of the AC line induced noise to cancel over the integration period. The oscillation frequency may also be greater, for example at or about 1 Khz. The oscillation frequency may also be a frequency less than the line frequency, for example, 30 Hz when the AC power input 105 is at 60 Hz. Having the oscillation frequency less than the line frequency may provide the advantage of minimizing the introduction of harmonic or inter-harmonic currents into the AC line. The oscillator 130 may provide multiple frequencies, for example, by deriving a secondary or tertiary frequency from a primary frequency. The oscillator 130 may alternatively provide a pseudorandom sequence by constructing a pseudorandom frequency generator using the frequency output from the oscillator 130. This may improve immunity to voltage noise on the line, as noise on the line may result in unwanted detection of high impedance when directly connected to the line. The frequency output from the oscillator 130 may be configured to improve immunity to narrow-band voltage noise on the AC power input 105 by providing one or more output frequencies including static, dynamic, random or pseudorandom frequencies. The oscillator 130 may provide one or more on/off or high/low cycles of the test load switch 140 to maximize the speed of detection of the presence or absence of a subject in the circuit.

With continued reference to FIG. 1, an output of the oscillator 130 may be further electrically connected to an input of the test load switch 135, such that the test load switch 135 is controlled by the oscillator 130. The test load switch 135 may be configured as an nMOS transistor, a pMOS transistor, a CMOS configuration, a bipolar junction transistor, a non-transistor switching element, such as a contactor or other device, or any combination of logic gates formed from transistors or other elements, such that a circuit path through the Z test load 140 may be made or broken or modulated in response to one or more signals from the oscillator 130, or some other source. The test load switch 135 may be an n-type metal-oxide-semiconductor field-effect transistor (MOSFET) with an input gate, a source, and a drain.

If an n-type MOSFET is used as the test load switch 135, the source may be electrically connected directly to the ground 195 of the impedance detection circuit and the drain may be electrically connected to the Z test load 140. The source may alternatively be electrically connected to the Z test load 140 and the drain may be electrically connected to the device power rail 145, for example, as illustrated in FIG. 1. The drain of the n-channel MOSFET may be electrically connected to the device power rail 145 and the source of the n-channel MOSFET may be electrically connected to a Z test load 140, which is further electrically connected to the ground 195. If a p-type MOSFET is used, it may be similarly electrically connected in the circuit. If desired, the test load switch 135 may include an element configured for inverting the gate voltage before presentation to the transistor or other element

The Z test load 140 may be configured as a resistor, a combination of resistors, a transistor acting in the ohmic or another region, transistors arranged to form a current sink, or any other element, combination of elements, or device configured to produce an effect measurable by a detector 150. If the Z test load 140 is a resistor, it may be designed to minimize the current passing through the Z test load 140 when that current is also passing through a subject, for example, a person installing the device. The total current drawn by the auxiliary supply 125, oscillator 130, detector 150 and the Z test load 140 is preferably less than a maximum safe current to avoid harm to the subject. For example, a maximum current that can pass through an electrical load simulating the human body may be provided by safety standards promulgated by nationally recognized testing labs. Since the level of current that produces harm is different for different frequencies, the maximum level will depend on the oscillator frequencies.

The output of the oscillator 130 may be electrically connected to an input of the detector 150, serving to synchronize the detector 150 with the activation of the test load switch 135. The detector 150 may be configured to accept an input power from the auxiliary power rail 185, an input signal from the device power rail 145, and a sync input signal from the output of the oscillator 130. The detector 150 may also be electrically connected to the ground 195, or any other power source or ground. The detector 150 may be configured to detect a variation in the current draw or voltage across the device power rail 145 due to the oscillating change in the current going through the Z test load 140. The detector 150 may also be configured to detect variations in a frequency response created by activation of the Z test load 140 when a subject, for example a person, is represented as present in the circuit. The detector 150 may be configured to output a signal in response to a change in the current of the Z test load 140.

The detector output signal from the detector 150 may increase as a variation of the voltage drop and/or current draw in the device power rail 145 increases, and decrease as the variation in the device power rail 145 decreases. The detector output signal may be limited to discrete digital values or may be analog or any other type of signal. The detector output signal may change as the inputs to the detector 150 change, or may be held to its value for designated periods of time before changing in order to delay turning on or turning off of the load to ensure that a sufficient electrical connection is made, and no subject is present in the electrical circuit before applying power to the main load 180. The detector 150 may also be configured such that the detector output signal decreases as the variation in the device power rail 145 increases and increases as the variation in the device power rail 145 decreases. The detector 150 may be configured such that the detector 150 may output different signals depending on the degree and magnitude of variance in the current traveling through, or voltage across, the Z test load 140 and/or the device power rail 145. The detector output signal may also depend on variations in the frequency response created by activating the Z test load 140.

The detector 150 may also be configured to detect variations in a frequency response created by activation of the Z test load 140 when a subject, for example a person, is represented as present in the circuit. For example, if the oscillator 130 is configured to output multiple frequencies, the detector 150 may detect the voltage variation on the device power rail 145 and respond based on the difference or ratio of the response at each frequency. Since the human body model 115 has a lower impedance at high frequencies, when detecting the voltage variation at the device power rail 145 to the current drawn by the Z test load 140, a relatively high voltage variation at a low frequency compared to the voltage variation at a high frequency may indicate the presence of a subject, rather than a metallic connection, between the power source 105 and the current limiting circuit 100. The detector output signal from the detector 150 may be a voltage, current, or other type of signal.

The detector 150 may be a narrowband detector or a synchronous detector implemented using a programmable system on a chip (SoC). The synchronous detector may also be implemented with an application specific integrated circuit (ASIC). The detector need not consist of only a single unit, but may comprise multiple discrete and/or integrated circuit elements used in combination to produce a desired function. In direct response to a change in the output of the oscillator 130, the synchronous detector may be configured to detect a change of voltage of, or current through, the device power rail 145 and/or the Z test load 140 and generate and/or send the detector output signal based on the variance thereof. The detector 150 may also be an asynchronous detector, which need not receive an input from the oscillator 130. The asynchronous detector may sample the current traveling through, or the voltage across, the device power rail 145 and/or the Z test load 140. The asynchronous detector may also sample variations in the frequency response created by the activation of the Z test load 140 and generate and/or send the detector output signal based on the sampled variance thereof.

With continued reference to FIG. 1, the detector 150 output may be electrically connected to an input of a detector low pass filter 155 to help prevent false detection due to brief noise pulses. The detector low pass filter 155 may include a resistor 155a and a capacitor 155b. The detector low pass filter 155 may also include a network of operational amplifiers; a combination of any of resistors, capacitors, or inductors; a programmable SoC; an ASIC; or any combination of discrete and integrated circuit elements. The detector low pass filter 155 may pass the detector output signal of the detector 150, or a portion thereof, depending on a corner frequency of the detector low pass filter 155. The corner frequency of the detector low pass filter 155 may be determined based on a desired RC time constant for the detection of variance in the current traveling through, or the voltage across, the device power rail 145 and/or the Z test load 140 by the detector 150 and/or created by activating the Z test load 140.

The output of the detector low pass filter 155 may be electrically connected to a first input 170a of a comparator 170 and the output of a power-up reset 160. The comparator 170 may be configured to accept a device power input from the device power rail 145 and/or an auxiliary power input from the auxiliary power rail 185. The comparator 170 may also be powered from the auxiliary power rail 185 and may be connected to the ground 195, or to another power source or ground. The comparator 170 may be configured to accept the output of the detector low pass filter 155 at the first comparator input 170a, and the output of a detection threshold signal source 165 at a second comparator input 170b. The comparator may also be configured such that the inputs 170a and 170b are oppositely or otherwise connected to the detector low pass filter 155 and the detection threshold signal source 165. Additionally, the comparator 170 may comprise more than two inputs, such as an input to receive an output from the oscillator 130 or an input corresponding to a logic operation of the comparator 170. The comparator 170 may be configured to include operational amplifiers, dedicated comparator chips, a programmable SoC, an ASIC, or a combination of discrete and analog circuit elements.

The comparator 170 compares the output of the detector low pass filter 155 to the output of the detection threshold signal source 165 and produces an output relating to the comparison. For example, if the output of the detector low pass filter 155 is lower than the output of the detection threshold signal source 165, the comparator 170 can output a “high” signal, a “low” signal, a signal which varies in relation to the difference of the values of the inputs 170a and 170b, or another type of signal. The comparator 170 output signal may also produce a “high” signal, a “low” signal, a signal which varies in relation to the difference in the values of the inputs 170a and 170b, or another type of signal if the output of the detector low pass filter 155 is higher than the output of the detection threshold signal 165. The comparator 170 may be configured to produce various signal types in response to its inputs. As the output of the detector low pass filter 155 varies due to a change in the detector output signal of the detector 150, the comparator 170 may continually compare the output of the detector low pass filter 155 to the output of the detection threshold signal source 165, or may compare the outputs at designated intervals.

The detection threshold signal source 165 may be configured to be a voltage source that provides an output at, below, or above the output of a power-up reset 160, depending on the operation of the comparator 170. The detection threshold signal source 165 may include a battery, a capacitor configured to hold a voltage, a zener diode connected to the auxiliary power rail 185 and the ground 195, an output from another circuit element, a programmable element, or a combination of discrete and analog circuit elements. The detection threshold signal source 165 may be electrically connected to input 170b of the comparator 170, for example, as shown in FIG. 1, although it may also be electrically connected to input 170a depending on a desired configuration of the comparator 170. In general, the value of the output of the detection threshold signal source 165 may be determined based on a desired threshold for which the output from the detector low pass filter 155 will cause the comparator 170 to vary its output and activate a load switch 175.

For example, if a low value output from the detector 150 indicates that there is a subject, such as a human body, electrically coupled with the device, the detection threshold signal source 165 may be configured to produce a value that will prevent the comparator 170 from substantially varying its output and activating the load switch 175. If a high value output is produced by the detector 150, the detection threshold signal source 165 may be configured to produce a value that will allow the comparator to vary its output and activate the load switch 175. The threshold signal source 165 may be configured in other ways, based on the input from the detector 150, the input from the detector low pass filter 155, a desired output of the comparator 170, or other design characteristics. The value of the output of the detection threshold signal source 165 may be static, dynamic, or programmable.

The power-up reset 160 may be configured to accept a device power input from the device power rail 145 and/or an auxiliary power input from the auxiliary power rail 185. The power-up reset 160 may also be configured to be powered even when the current limiting circuit 100 is disconnected and the device power rail 145 is not capable of powering the power-up reset 160. The power-up reset 160 may be powered from the auxiliary power rail 185 and may also be connected to the ground 195 or another power source or ground. The power-up reset 160 may include a battery, a pull-up resistor, a pull-down resistor, a transistor operating in the ohmic or other region, a capacitor configured to hold a voltage, a zener diode electrically connected to the auxiliary power rail 185 and the ground 195, an output from another circuit element, a programmable element, or a combination of discrete and analog circuit elements.

When power is first applied to the current limiting circuit 100, the power-up reset 160 pulls down the output of the low pass filter 155, such that the first input 170a to the comparator 170 is low compared to the detection threshold signal 165, thereby turning off main load switch 175. This will cause the initial state of the main load 180 to be off, thus substantially preventing current flow through the main load 180. The power up reset 160 maintains this state until a stable condition is reached and a determination can be made whether a subject is present in the circuit. This may occur within 50 and 250 ms. If there is no subject present in the circuit, the comparator 170 can then compare the output of the low pass filter 155 to the detection threshold signal 165 and output a “high” signal since the output of the low pass filter 155 is higher than the detection threshold signal 165. The power-up reset 160 may also be connected to any of the inputs or outputs of the comparator 170 or the input of the load switch 175 to control its initial value. Also, the logic and signal values discussed above can be reversed or otherwise changed as desired. Signal inversion may also be present among the inputs and outputs, affecting logic and signal values. The power-up reset 160 may also be configured to deactivate once an initial or other period has passed and/or to activate when the device is disconnected from the power input 105.

The output of the comparator 170 may be electrically connected to an input of a load switch 175. The load switch 175 may be configured as a bipolar or field-effect transistor or another type of switch. For example, the load switch 175 may be configured as an nMOS transistor, a pMOS transistor, a CMOS configuration, a bipolar junction transistor, a non-transistor switching element such as a contactor or other device, or a combination of logic gates formed from transistors and/or other elements. For example, the load switch 175 may be an n-type MOSFET with an input gate, a source, and a drain. The output of the comparator 170 may be connected to the input gate of the n-type MOSFET. The drain of the n-channel MOSFET may be electrically connected to the main load 180, and the source of the n-channel MOSFET may be electrically connected to the ground 195. In practice, the main load 180 may be further electrically connected to the device power rail 145. If a p-type MOSFET is used, it may be similarly electrically connected in the circuit. The load switch 175 may include an element configured for inverting the gate voltage before presentation to the transistor or other element.

When the output of the comparator 170 is “low”, the load switch 175 is turned off and the main load 180 is also turned off, as substantially no current is allowed to flow through the load switch 175. When the output of the comparator 170 is “high,” the load switch 175 is turned on, thereby allowing current to flow through both the main load 180 and the load switch 175, and the main load 180 is turned on. For example, the load switch 175 may be configured to turn on when the output of the comparator 170 is “low” and turn off when the output of the comparator 170 is “high.” The load switch 175 need not be controlled by the comparator 170. The detector 150, detector low pass filter 155, power-up reset 160, detection threshold signal 165, comparator 170, and load switch 175 may be configured such that, as the variance in the current traveling through, or the voltage across, the device power rail 145 is increased or decreased, the load switch 175 may be turned on or off in response to such variance.

With continued reference to FIG. 1, the main load 180 may be an LED-based light or CFL. The main load 180 may be connected such that electrical current flows through it from a first connection point with the device power rail 145 to a second connection point with a terminal of the load switch 175. This configuration may be varied. For example, the layout of the main load 180 may be reversed with that of the load switch 175 if the load switch 175 comprises a p-channel MOSFET. The current limiting circuit 100 may be used with any electrical device that draws power. Accordingly, the main load 180 is not limited for use exclusively with an LED-based light or CFL.

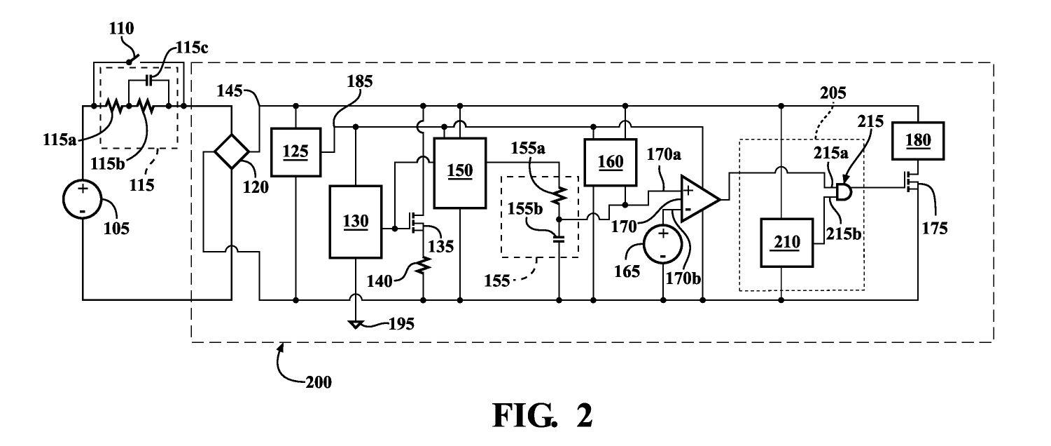

FIG. 2 is an electrical schematic diagram of a current limiting circuit 200 similarly configured as the previously described current limiting circuit 100, but may also include a detection validation circuit 205. The detection validation circuit generally prevents the main load 180 from being energized until power has been applied to the circuit 200 for a predefined amount of time, and a subject is not detected in the circuit between the power source 105 and current limiting circuit 200. The output from the comparator 170 in FIG. 2 may be electrically connected to an input of the detection validation circuit 205. An output of the detection validation circuit 205 may be electrically connected to the input of the load switch 175. The detection validation circuit 205 may comprise a detection validation timer 210 and a detection logic circuit 215.

The detection validation timer 210 may be a digital counter that outputs a “low” signal initially and outputs a “high” signal after an amount of time has lapsed. The amount of time may be pre-determined, variable or programmable. The digital counter may be single or multi-bit. The digital counter may be configured to include one or more flip-flops in single or multi-bit configuration; integrated circuit counters; programmable SoCs; or discreet, analog, or a combination of discrete and analog circuit elements. The detection validation timer 210 may be powered by the device power rail 145 or the auxiliary power rail 185. The detection validation timer 210 may also be connected to the ground 195 or another power source or ground. The digital counter may be asynchronous or synchronous and may be connected to oscillator 130. Alternatively, the detection validation timer 210 may be an analog counter.

With continued reference to FIG. 2, the output of the detection validation timer 210 may be connected to a first input 215a of the detection logic circuit 215, and the output of the comparator 170 may be connected to a second input 215b of the detection logic circuit 215. The detection logic circuit 215 may be powered by the device power rail 145 or the auxiliary power rail 185. The detection logic circuit 215 may also be connected to the ground 195 or to another power source or ground. The detection logic circuit 215 may be configured as a logic gate. For example, when signals on both the first input 215a and the second input 215b to the detection logic circuit 215 are “high,” the detection logic circuit 215 will output a “high” signal. Otherwise, the detection logic circuit 215 will output a “low” signal. These signals may also be reversed, analog, or of another type. The detection logic circuit 215 may be constructed with an AND gate, an NAND gate, a combination of logic gates, or a combination of discrete circuit elements. Any of the inputs to the detection logic circuit 215 or its output may be inverted by an inversion element. The output of the detection logic circuit 215 may be connected to the input of the load switch 175, a description of which has been provided above. The main load 180 will be energized only when a direct electrical connection is detected between power source 105 and current limiting circuit 200, and the detection validation timer has expired.

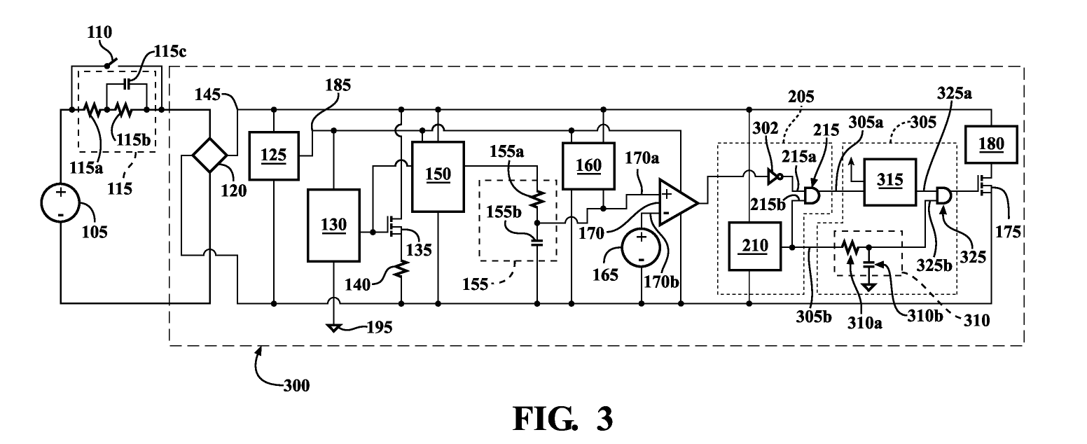

FIG. 3 is an electrical schematic diagram of a current limiting circuit 300 similarly configured as the previously described current limiting circuit 200, but may also include a latching main load shut-off circuit 305. The function of this added circuit is to cause the main load 180 to be de-energized if a subject is detected in the circuit between power source 105 and current limiting circuit 300, and to remain de-energized until power is cycled or some other reset function is activated. This may prevent momentary metallic contacts from turning on the main load, possibly causing a hazard to a subject in the case of an intermittent connection. Detection validation circuit 205 may be modified to include a logic inverter 302 electrically connected to the output from comparator 170 and the first input 215a of the detection logic circuit 213. Logic inverter 302 may output a voltage representing the opposite logic-level to its input received from comparator 170. The output from the detection logic circuit 215 may be electrically connected to a first input 305a of the main load shut-off circuit 305 and the output from the detection validation timer 210 may be further electrically connected to a second input 305b of the main load shut-off circuit 305. The main load shut-off circuit 305 may be configured to include a detection validation timer filter 310, a main load shutoff latch 315, and a main load detection logic circuit 325. The main load shut-off circuit 305 may also have a different configuration, for example, if the detection validation circuit 205 is not present.

With continued reference to FIG. 3, the output of the detection validation timer 210 may be electrically connected to an input of the detection validation timer filter 310, per second input 305b of the main load shut-off circuit 305. The detection validation timer filter 310 may be configured to include a resistor 310a and a capacitor 310b. The detection validation timer filter 310 may also be configured to include a network of operational amplifiers; a combination of any of resistors, capacitors, or inductors; a programmable SoC; an ASIC; or any combination of discrete and integrated circuit elements. The detection validation timer filter 310 may pass an output signal of the detection validation timer 210, or a portion thereof, depending on a corner frequency of the detection validation timer filter 310. The corner frequency of the detection validation timer filter 310 may be determined based on a target frequency response and/or RC time constant for the output of the detection validation timer 210. The detection validation timer filter 310 may be configured to have a static or dynamic cutoff frequency depending on the target frequency response and/or RC time constant for detection.

The output of the detection logic circuit 215 may be electrically connected to an input of the main load shut-off latch 315. The main load shut-off latch 315 may be electrically connected to the detection logic circuit 215 per the first input 305a of the main load shut-off circuit 305. The output of the main load shut-off latch 315 may be connected to an input 325a of the main load detection logic circuit 325. The main load shut-off latch 315 may be powered by the device power rail 145 or the auxiliary power rail 185. The main load shut-off latch 315 may also be connected to the ground 195 or another power source or ground. The main load shut-off latch 315 may be constructed from an electrical flip-flop, such as a D, SR, or other type of flip-flop or latch. The main load shut-off latch 315 may also include a network of operational amplifiers; a combination of any of resistors, capacitors, or inductors; a programmable SoC; an ASIC; or any combination of discrete and integrated circuit elements. The main load shut-off latch 315 may be asynchronous or synchronous and may be connected to oscillator 130 or the detection validation timer 210.

The input to the main load shut-off latch 315 may be time delayed so as to prevent false triggers and allow the settling of signals initially produced by the circuit. This delay may be accomplished, for example, with an RC filter or a digital filter. The main load shut-off latch 315 may have “preset” and “clear” inputs that can be connected in the circuit as desired. The main load shut-off latch 315 may have two outputs, one of which may reflect an opposite digital value of the other. The main load shut-off latch 315 may have a “clock” input that may indicate to the main load shut-off latch 315 that it should accept a state change, if a state change also happens to be indicated. The “clock” input need not be electrically connected to any sort of clocking element, such as the oscillator 130 or the detection validation timer 210, and may be electrically connected to the output of a logic element. The main load shut-off latch 315 may be configured to input or output both digital and analog signals. The main load shut-off latch 315 may also be electrically connected in the circuit based on the specific characteristics of the latch that is used The main load shut-off latch 315 may also serve as a safety feature for the current limiting circuit 300. The main load shut-off latch 315 may be configured to prevent the activation of the load switch 175 once the current limiting circuit 300 detects a subject, for example a person, is electrically connected to the circuit and until the device is disconnected and power is reapplied. For example, the main load shut-off latch 315 may be configured, such that if the device power rail 145 is found to be active, but the output of the comparator 170 indicates that there is a person electrically connected to the circuit, the main load shut-off latch 315 will be triggered and produce an output that will prevent both present and future activation of the load switch 175. The main load shut-off latch 315 may also be configured to reset to its initial state when power is removed from the circuit and reapplied.

With continued reference to FIG. 3, the output of the main load shut-off latch 315 may be connected to a first input 325a of the main load detection logic circuit 325 and the output of the detection validation timer filter 310 may be connected to a second input 325b of the main load detection logic circuit 325. The main load detection logic circuit 325 may be powered by the device power rail 145 or the auxiliary power rail 185. The main load detection logic circuit 325 may also be connected to the ground 195 or to another power source or ground. The detection logic circuit may be configured as a logic gate that behaves in a manner, such that when signals on both the first input 325a and the second input 325b to the main load detection logic circuit 325 are “high,” the main load detection logic circuit 325 will output a “high” signal. Otherwise, the main load detection logic circuit 325 will output a “low” signal. The main load shut-off latch 315 starts at power-up in the “on” state, which would normally energize the main load 180. However, the output of main load logic detection circuit 325 is initially off, because the detection valid timer 210 output is off at power up. This prevents the main load 180 from being energized. At the end of the detection valid time, if no subject is detected in the electrical circuit, the output of the detection valid timer 210 goes high. Because both inputs of the main load detection circuit 325 are now high, the load switch 175 is turned on. If at any time after the detection valid timer interval has expired, a subject is detected in the electrical circuit, the output of the detection logic circuit 215 will go high, latching a low output from the main load shutoff latch 315 into input 325a of the main load detection circuit 325, thereby disabling the output from the load detection logic circuit 325 and the load switch 175.

The main load detection logic circuit 325 signals may be reversed, analog, or of another type. The main load detection logic circuit 325 may be configured to include an AND gate, an NAND gate, a combination of logic gates, or a combination of discrete circuit elements. Any of the inputs to the main load detection logic circuit 325 or its output may be inverted by an inversion element. The output of the main load detection logic circuit 325 may be connected to the input of the load switch 175, a description of which has been provided above.

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A current limiting circuit for use with an electrical device, comprising:
a test load;
a test load switch operable for varying an electrical current flowing through the test load;
a detector electrically connected to the test load and operable for detecting variations in an electrical characteristic of the test load and generating a detector output signal indicative of said electrical characteristic;
a detection threshold signal source operable for producing a detection threshold signal;
a comparator electrically connected to the detector and the threshold signal source, the comparator operable for generating a load switch control signal based at least in part on the detector output signal and the detection threshold signal; and
a load switch electrically connected to the comparator and operable for adjusting a current flow through a main load in response to the load switch control signal.

2. The claim of claim 1, wherein the electrical characteristic is at least one of current flow through the test load, voltage drop across the test load and change in frequency.

3. The current limiting circuit of claim 1 further comprising an oscillator electrically connected to at least one of the test load switch and the detector.

4. The current limiting circuit of claim 3, wherein operation of the detector is substantially synchronized with the operation of the test load switch.

5. The current limiting circuit of claim 1 further comprising a detector filter electrically connected to the detector for receiving the detector output signal and passing a least a portion of the signal to the comparator.

6. The current limiting circuit of claim 1 further comprising a power-up reset operably connected to the detector for adjusting the detector output signal.

7. The current limiting circuit of claim 6, wherein the power-up reset adjusts the detector output signal prior to the signal being delivered to the comparator.

8. A current limiting circuit for use with an electrical device, comprising:
a test load;
a test load switch operable for varying an electrical current flowing through the test load;
a detector electrically connected to the test load and operable for detecting variations in an electrical characteristic of the test load and generating a detector output signal indicative of said electrical characteristic;
a detection threshold signal source operable for producing a detection threshold signal;
a comparator electrically connected to the detector and the threshold signal source, the comparator operable for generating a load switch control signal based at least in part on the detector output signal and the detection threshold signal;
a detection validation timer operable for outputting a variable detection validation timer signal;
a detection logic circuit electrically connected to the detection validation timer and the comparator, the detection logic circuit operable for generating a detection logic circuit output signal based at least in part on the detection validation timer signal and the load switch control signal; and
a load switch electrically connected to the comparator and operable for adjusting a current flow through a main load in response to at least one of the load switch control signal and the detection logic circuit output signal.

9. The claim of claim 8, wherein the electrical characteristic is at least one of current flow through the test load, voltage drop across the test load and change in frequency.

10. The current limiting circuit of claim 9, wherein the load switch is operable for adjusting the current flow through the main load in response at least in part to the detection logic circuit output signal.

11. The current limiting circuit of claim 8 further comprising a main load shutoff latch electrically connected to the detection logic circuit and operable for outputting a main load shutoff latch output signal for preventing operation of the load switch in response to a signal received from the detection logic circuit.

12. The current limiting circuit of claim 11 further comprising a main load detection logic circuit electrically connected to the main load shutoff latch and the detection validation timer, the main load detection logic circuit operable for generating a main load detection logic circuit output signal based at least in part on the main load shutoff detection logic circuit output signal and the detection validation timer signal.

13. The current limiting circuit of claim 11 further comprising a detection validation timer filter electrically connected to the detection validation timer, wherein the detection validation timer filter passes at least a portion of the detection validation timer signal received from the detection validation timer to the main load detection logic circuit.

14. A method for limiting the current of an electrical device, the method comprising:
inducing a current through a test load;
detecting an electrical characteristic of the test load;
generating a test signal representative of the detected electrical characteristic;
comparing the test signal with a threshold signal; and
operating a main load switch based at least in part on the comparison of the test signal with the threshold signal.

15. The method claim 14, wherein the electrical characteristic is at least one of current flow, voltage drop and change in frequency.

16. The method of claim 14 further comprising:
generating detection validation timer signal;
delaying operation of the main load switch for a period of time based on a value of the detection validation timer signal.

17. The method of claim 16, wherein the value of the detection validation signal varies with time.

18. The method of claim 16 further comprising disabling operation of the load switch based at least in part on one of the value of the detection validation timer signal and a result of the comparison between the test signal with the threshold signal.

19. The method of claim 18 further re-enabling operation of the load switch by terminating power to the electrical device.
